(19) United States
(12) Patent Application Publication
(10) Pub. No.: US 2009/0027429 A1
(43) Pub. Date: Jan. 29, 2009

(54) INKJET IMAGE FORMING APPARATUS AND METHOD TO CONTROL THE SAME

(75) Inventor: Myung Song JUNG, Gunpo-si (KR)

Correspondence Address: STANZIONE & KIM, LLP, 919 18TH STREET, N.W., SUITE 440, WASHINGTON, DC, 20006, US

(73) Assignee: Samsung Electronics Co. Ltd., Suwon-si (KR)

(21) Appl. No.: 12/062,628

(22) Filed: Apr. 4, 2008

(30) Foreign Application Priority Data
Jul. 24, 2007 (KR) 2007-74169

(51) Int. Cl. B41J 2/05; B41J 29/38; B41J 2/135

(52) U.S. Cl. 347/10; 347/9; 347/56; 347/40; 347/47

(57) ABSTRACT

An inkjet image forming apparatus and a method to control the same are provided to prevent a reduction in the print image quality due to inkjet nozzle deformation. The trajectory direction of ink inclined by inkjet nozzle deformation is corrected by controlling the amount of heat generated by a plurality of heaters that are arranged in parallel to the conveyance direction of paper for each inkjet nozzle provided on an inkjet head chip mounted in an inkjet print head.

### CROSS-REFERENCE TO RELATED APPLICATIONS

This application claims priority under Korean Patent Application No. 2007-0074169, filed on Jul. 24, 2007 in the Korean Intellectual Property Office, the disclosure of which is incorporated herein by reference in its entirety.

### BACKGROUND OF THE INVENTION

1. Field of the Invention

The present general inventive concept relates to an inkjet image forming apparatus and a method to control the same to prevent a reduction in the print image quality due to deformation of nozzles of a print head.

2. Description of the Related Art

A general inkjet image forming apparatus is designed to provide a printout with a uniform optical density of an image printed on it. The optical density of an image printed on a sheet of paper may become uneven when some nozzles are defective so that printing cannot be performed or when ink droplets jetted through some nozzles hit incorrect positions on the sheet of paper so that neighboring dots are continuously printed on the sheet of paper to cause a reduction in the ratio of the area of the dots to the total area of the sheet of paper.

The ratio of the area of the dots may be reduced, for example when the dots are printed so as to overlap each other or when the sizes of dots are reduced. Especially, the printing of dots so as to overlap each other negatively affects the optical density of the printout.

Dots may be printed so as to overlap if errors of the trajectory angle of ink jetted through nozzles caused by deformation of the nozzles are out of an appropriate allowable range. When nozzles are deformed in the direction in which the odd and even nozzle rows of each color are arranged (i.e., the vertical direction in which a print medium is conveyed), the deformation more negatively affects the optical density to make it uneven than when nozzles are deformed in the direction in which nozzles are arranged in each row (i.e., the horizontal direction parallel to the transverse direction of the print medium).

The print head includes at least one head chip and the head chip includes a plurality of nozzles corresponding to at least one color. To increase the print image resolution, the plurality of nozzles are generally arranged such that odd nozzles are not aligned with even nozzles by a regular interval.

In a method to manufacture nozzles of an ink print head, a nozzle plate is bonded to a dry film through heating and pressing at a high temperature. Here, small thermal expansion occurs at the lower portion of the ink print head where the dry film and substrate of the print head are provided while great thermal expansion occurs at the upper portion where the nozzle plate is provided. This slightly deforms an inner portion of the nozzle plate, which is then bonded to the dry film.

The print head is then cooled at the room temperature, which increases the deformation caused at the high temperature. This results in that the central axes of nozzles are inclined to change the trajectory angles of ink jetted through the nozzles.

When the surface of a head chip of a print head with deformed nozzles is measured using a surface profilometer, the entrance of each hole of an odd nozzle 10A and an even nozzle 10B is not flat and instead is curved due to deformation of the nozzles as illustrated in FIG. 1. Although both the odd and even nozzles are deformed in this example, either the odd or even nozzle may be selectively deformed.

A first tangent line 11A represents the gradient of a curved portion of the entrance of the odd nozzle 10A when the deformation of the odd nozzle 10A is not great and a second tangent line 12A represents the gradient of a curved portion of the entrance of the odd nozzle 10A when the deformation of the odd nozzle 10A is relatively great. Third and fourth tangent lines 11B and 12B each represent the gradient of a curved portion of the entrance of the even nozzle 10B when the even nozzle 10B is deformed, where the fourth tangent line 12B represents the gradient with a relatively great deformation.

The included angle between the first and third tangent lines 11A and 11B is smaller than the included angle between the second and fourth tangent lines 12A and 12B. This indicates that a position on a sheet of paper at which ink hits the sheet of paper approaches a reference position at which ink hits the sheet of paper at right angles as the nozzle deformation decreases.

When the nozzle deformation caused at the print head is small, for example when an odd nozzle 20A is slightly deformed and an even nozzle 20B is not deformed, as illustrated in FIG. 2A, ink droplets jetted through the odd nozzle 20A hit a sheet of paper at a position, deviating a specific distance d1 from a reference position at which ink droplets hit the sheet of paper at right angles, since the odd nozzle 20A is deformed and ink droplets jetted through the even nozzle 20B hit the sheet of paper at right angles since the even nozzle 20B is not deformed.

The distance d11 between printed dots is roughly uniform as illustrated in FIG. 2B if nozzles of one of the odd or even nozzle rows are deformed to a small extent as illustrated in FIG. 2A. That is, dots printed through the odd and even nozzles are distributed uniformly over the sheet of paper so that the ratio of the area of the dots to the total area of the sheet of paper is large.

In another example, when the nozzle deformation caused at the print head is great, for example when an odd nozzle 30A is significantly deformed and an even nozzle 30B is not deformed, as illustrated in FIG. 3A, ink droplets jetted through the odd nozzle 30A hit a sheet of paper at a position, deviating a specific distance d2 from a reference position at which ink droplets hit the sheet of paper at right angles, since the odd nozzle 30A is deformed and ink droplets jetted through the even nozzle 30B hit the sheet of paper at right angles since the even nozzle 30B is not deformed.

The distance between printed dots is not uniform, alternating between a large distance d12 and a small distance as illustrated in FIG. 3B, if nozzles of one of the odd or even nozzle rows are deformed to a great extent as illustrated in FIG. 3A. Accordingly, dots printed through the odd and even nozzles are distributed unevenly over the sheet of paper so that the ratio of the area of the dots to the total area of the sheet of paper is reduced to be smaller than that of FIG. 2B.

Nozzles may be deformed in a chamber forming process and a nozzle forming process in another nozzle manufacturing method which employs a monolithic process in which ink chambers to receive ink from an ink feedhole and a nozzle plate are formed of the same material. Chemical-Mechanical Polishing (CMP) is applied to form ink chambers at a uniform thickness. Here, the chambers and a sacrifice layer used to form an ink supply flow path are etched to different depths according to the difference between their levels of selectivity in the polishing process since the material of the chambers is different from that of the sacrifice layer. The chambers will be more deeply etched if the material of the sacrifice layer is harder than the material of the chambers and the sacrifice layer will be more deeply etched if the material of the chambers is harder than the material of the sacrifice layer. This will form a slope in the direction toward the more deeply etched portion. The sacrifice layer generally exhibits soft characteristics. Thereafter, nozzles are formed through spin coating or with a dry film and the sacrifice layer is then removed. The nozzles are further deformed while the sacrifice layer supporting the nozzles is removed. This increases the slope of the nozzles, making them more defective.

FIG. 4 is a graph illustrating distributions of the angles (Even-Odd Angle) between the trajectory angles of odd and even nozzles in a normal process of manufacturing a print head according to the former nozzle manufacturing method and in a Multi-Functional Structure (MFS) process of manufacturing a print head according to the latter nozzle manufacturing method.

Nozzles may be deformed in all methods to manufacture nozzles of the print head including the two nozzle manufacturing methods described above. Particularly, the deformation occurs throughout the head chip due to the characteristics of semiconductor processes to manufacture the head chip. That is, deformation does not locally occur in some nozzles of the head chip and instead nozzle deformation usually occurs on a line by line basis since a row of odd nozzles and a row of even nozzles form a line.

Further, when the print head includes a plurality of head chips arranged in the transverse direction of paper to print an image on a line by line basis, nozzle deformation may individually occur in each head chip, further reducing the image quality.

Even when the print head has a single head chip, the position at which ink hits a print medium may deviate from the reference position, causing a reduction in the image quality, if the distance from the head chip to the print medium falls out of an appropriate allowable range in a process of mounting the head chip on the print head.

### SUMMARY OF THE INVENTION

The present general inventive concept provides an inkjet image forming apparatus and a method to control the same which can prevent a reduction in the print image quality due to nozzle deformation that may occur in at least one head chip mounted on a print head of the apparatus.

Additional aspects and utilities of the present general inventive concept will be set forth in part in the description which follows and, in part, will be obvious from the description, or may be learned by practice of the general inventive concept.

The foregoing and/or other aspects of the present general inventive concept may be achieved by providing an inkjet image forming apparatus including a head chip including a plurality of nozzles to jet ink, a plurality of heaters arranged for each of the plurality of nozzles to control an ink trajectory angle of the nozzle, and a heater driver to drive the plurality of heaters, wherein the heater driver includes at least one heater switch to allow a heater current to flow through the plurality of heaters which are connected in series, at least one auxiliary resistor connected to a connection point between the plurality of heaters, and at least one auxiliary switch to allow a heater current to flow through the at least one auxiliary resistor, and wherein the current flowing through each of the plurality of heaters is provided according to operations of the at least one heater switch and the at least one auxiliary switch.

Each of the at least one heater switch and the at least one auxiliary switch may include a transistor, and the heater driver may further include a setter to set an operating state of the at least one auxiliary switch.

The setter may include at least one switch and may output a control pulse having at least two levels according to a setting of the at least one switch, and the setting of the at least one switch of the setter may be fixed using a fusing device.

The setter may receive a signal to control the at least one heater switch and outputs a control pulse.

The plurality of heaters may be arranged in parallel in an ink chamber of each nozzle.

The plurality of heaters may be two heaters connected in series and arranged in parallel to a conveyance direction of a print medium.

The plurality of heaters for each nozzle may each include a resistance heating body and each resistive heating body of each nozzle may have a different resistance value.

The foregoing and/or other aspects of the present general inventive concept may also be achieved by providing a method of controlling an inkjet image forming apparatus, including determining a trajectory angle of ink ejected from each of a plurality of nozzles on a head chip, and selectively redirecting the trajectory angle of ink ejected from each of the nozzles by controlling an amount of heat applied to different portions of each of the nozzles.

The selectively redirecting the trajectory of the ink ejected may include setting a correction value to allow ink ejected by a deformed nozzle to hit a reference position on a print medium such that ink jetted by the deformed nozzle hits the print medium at right angles.

The selectively redirecting the trajectory angle of ink ejected from each of the nozzles may be performed by providing a plurality of heaters for each nozzle

Controlling an amount of heat generated by the plurality of heaters may include controlling current flowing through the plurality of heaters.

The plurality of heaters for each nozzle may be disposed within an ink chamber.

The determining of the trajectory angle may include comparing the trajectory angle of ink ejected from each of the plurality of nozzles on a head chip to a head chip print pattern having a plurality of reference positions corresponding to a predetermined trajectory angle of ink ejected from the nozzles of the head chip.

The selectively redirecting of the trajectory angle of ink ejected from each of the nozzles may include applying a pulsed signal to control a time that the amount of heat is applied to the different portions of each of the nozzles.

The foregoing and/or other aspects of the present general inventive concept may also be achieved by providing an inkjet nozzle correction system, including a head chip including a plurality of inkjet nozzles arranged on the head chip in a first group and a second group, a plurality of heating elements disposed in an ink chamber of each inkjet nozzle of each group, and a heater driver to selectively apply current to each of the plurality of heating elements of each nozzle such that a first current is applied to one of the plurality of heating elements of each nozzle of the first group of nozzles and a second current is applied to one of the plurality of heating elements of each nozzle of the second group of nozzles.

Each inkjet nozzle may include two heating elements, each having a different resistive value.

The heater driver may include a plurality of switches to selectively apply each current.

The heater driver may further include fused switching settings, the output of which may be used to control the plurality of switches to selectivity apply each current.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates how the trajectory angles of nozzles of a print head are changed due to deformation of the nozzles;

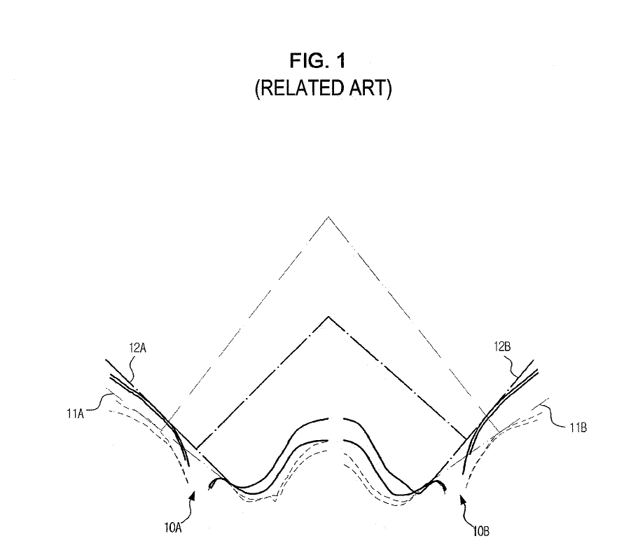

FIG. 2A illustrates how ink droplets are jetted through odd and even nozzles on a print head;

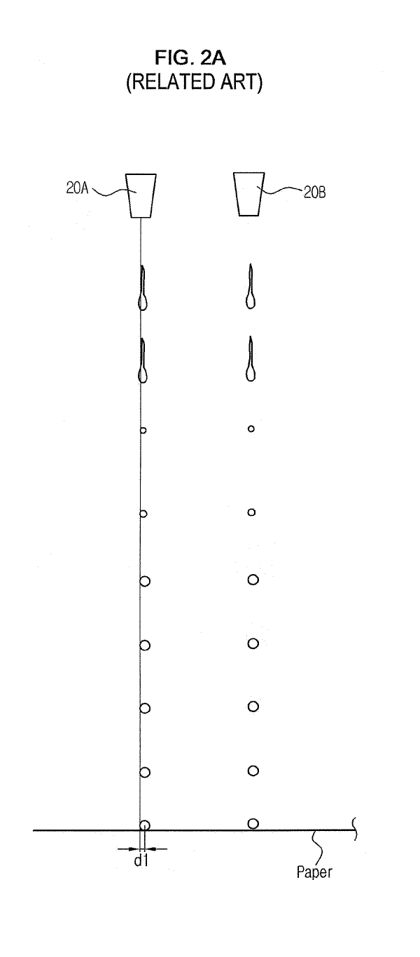

FIG. 2B illustrates an arrangement of dots printed through the nozzles as illustrated in FIG. 2A;

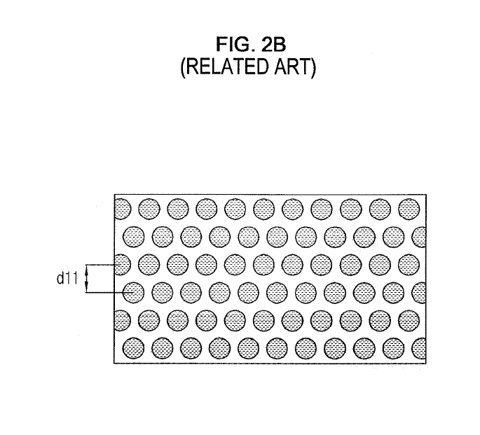

FIG. 3A illustrates how ink droplets are jetted through odd and even nozzles on a print head;

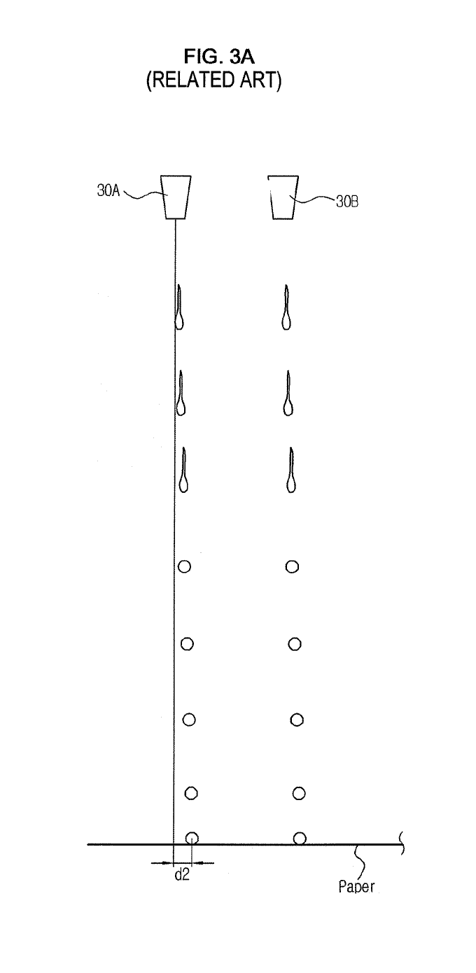

FIG. 3B illustrates an arrangement of dots printed through the nozzles as illustrated in FIG. 3A;

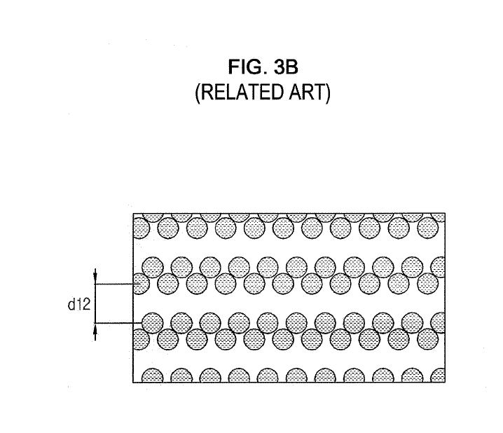

FIG. 4 is a graph illustrating distributions of the angles between the trajectory directions of odd and even nozzles according to the chip type of a print head;

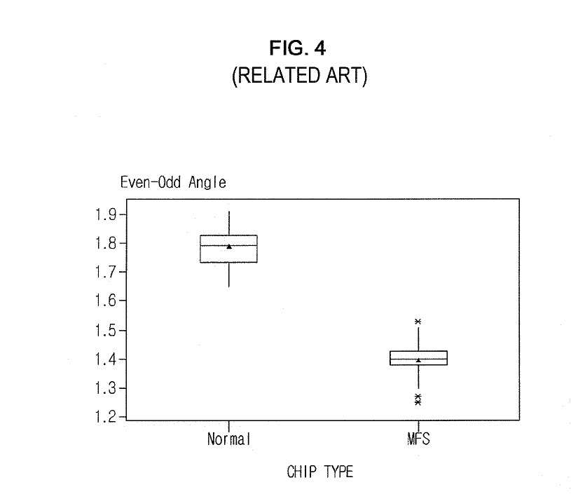

FIG. 5 illustrates an arrangement of heaters and nozzles applied to a print head according to the general inventive concept;

FIG. 6 is a circuit diagram illustrating a heater driver according to an embodiment of the general inventive concept;

FIG. 7 is a circuit diagram illustrating a heater driver according to another embodiment of the general inventive concept;

FIG. 8 illustrates the timing of signals applied to a heater driver to drive a plurality of heaters according to an embodiment of the general inventive concept;

FIG. 9A illustrates a head chip print pattern including an arrangement of dots printed with ink droplets jetted through odd and even nozzles on a head chip of a print head when the odd and even nozzles are not deformed such that the jetted ink droplets hit reference positions on a sheet of paper at right angles;

FIG. 9B illustrates a head chip print pattern including an arrangement of dots printed with ink droplets jetted through odd and even nozzles on a head chip of a print head when the odd and even nozzles are deformed such that the jetted ink droplets hit positions above the reference positions on a sheet of paper; and

FIG. 9C illustrates a head chip print pattern including an arrangement of dots printed with ink droplets jetted through odd and even nozzles on a head chip of a print head when the odd and even nozzles are deformed such that the jetted ink droplets hit positions below the reference positions on a sheet of paper.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

First, a description will be given of an inkjet image forming apparatus and a method to control the same according to an embodiment of the general inventive concept.

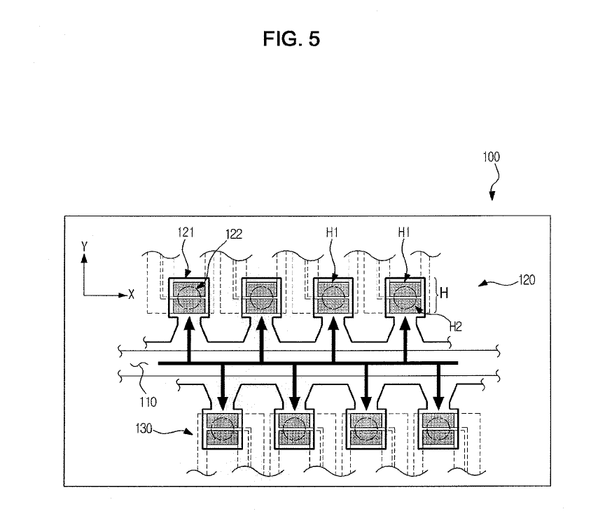

In general, although an inkjet head chip illustrated in FIG. 5 includes an ink feedhole corresponding to one color, through which ink of the color is supplied, and a plurality of nozzles arranged at both sides of the ink feedhole, the general inventive concept is not limited to this head chip structure. For example, when a variety of colors are used, an ink feedhole and a plurality of nozzles at both sides of the ink feedhole are individually provided for each of the colors.

The inkjet head chip may include electronic logic and pad portions not illustrated to exchange power and control signals with a controller of the apparatus.

The characteristics of a head chip can be estimated by performing test printing of characteristic patterns after the head chip is manufactured through general semiconductor manufacturing processes. From the estimation results, it is possible to determine the ink trajectory direction inclined by nozzle deformation and the extent of the inclination. A general method to determine the inclined trajectory direction and the extent of the inclination is for a user to independently view the patterns on the test print. Another method may also be employed in which the test-printed patterns are scanned using a scanner and the scanned image is then analyzed using an image analysis algorithm to determine the inclined trajectory direction and the extent of the inclination.

Estimation results of the head chip may indicate that the ink trajectory directions of a row of odd nozzles or a row of even nozzles have been inclined due to deformation of the nozzles in a vertical direction Y parallel to the direction in which paper is conveyed. Generally, all nozzles of the rows of odd and even nozzles or all nozzles of one of the row of odd nozzles or the row of even nozzles are deformed due to the characteristics of the semiconductor manufacturing processes.

In the inkjet image forming apparatus according to an embodiment of the general inventive concept, when estimation results of the head chip indicates that nozzles of the head chip have been deformed in the vertical direction so that the distance between each row of dots printed by the row of odd nozzles and each row of dots printed by the row of even nozzles is not uniform, the trajectory angles of the deformed nozzles are controlled to correct the distance between the rows of dots to be uniform. To accomplish this, the inkjet image forming apparatus can control the operations of a plurality of heaters corresponding to each nozzle.

More specifically, as illustrated in FIG. 5, an inkjet head chip 100 mounted on a print head of the inkjet image forming apparatus (not illustrated) according to an embodiment of the general inventive concept has an ink feedhole 110 formed in the inkjet head chip 100 to allow ink to be supplied from an ink supply unit (not illustrated) to each nozzle. The inkjet head chip 100 also includes a nozzle portion including first and second nozzle groups 120 and 130 having a plurality of nozzles which are formed so as to communicate with the ink feedhole 110 in order to receive ink from the ink feedhole 110 and which are arranged in a horizontal direction X parallel to the transverse direction of a sheet of paper.

The first nozzle group 120 includes a row of odd nozzles located at the upper side of the ink feedhole 110 and the second nozzle group 130 includes a row of even nozzles located at the lower side of the ink feedhole 110.

In this embodiment, a plurality of heaters H1 and H2 to heat ink are provided for each nozzle 121, regardless of whether it is an even or odd nozzle in order to control the trajectory angle (or direction) of ink jetted through the nozzle.

The plurality of heaters H1 and H2 can be formed by dividing one resistance heating body H into two sections. Each of the plurality of heaters H1 and H2 can have a resistance value that is twice as high as the resistance value of heating body H since it has a length equal to that of the resistance heating body and a width that is half that of the resistance heating body. The two divided heaters H1 and H2 can be connected in series so that the total resistance of H1 and H2 becomes four times as high as that of the resistance heating body H since the resistance of each of the heaters connected in series is twice as high as that of the resistance heating body H. The two divided heaters H1 and H2 are arranged in parallel in an ink chamber 122 of each nozzle 121 in a vertical direction Y parallel to the direction in which paper is conveyed. The purpose of arranging the heaters H1 and H2 in the vertical direction Y is to control the trajectory angle in the vertical direction.

In an embodiment where the two divided heaters H1 and H2 are provided in an ink chamber 122, if the time required to reach a temperature at which ink boils (i.e., the time required to generate bubbles) at each of the heaters H1 and H2 is set to be equal, ink will boil simultaneously at the heaters H1 and H2 to allow ink droplets to be jetted in the central axis direction of the nozzle 121.

If the time required to generate bubbles at each of the heaters H1 and H2 is set to be different, ink will not boil simultaneously at the two divided heaters H1 and H2 to allow ink droplets to be jetted in an inclined direction, deviating from the central axis direction of the nozzle 121.

Based on this fact, the operations of the two divided heaters H1 and H2 are controlled to cause a difference between their bubble generation times when the trajectory direction has been inclined to one side such that it is not perpendicular to the surface of a sheet of paper, thereby compensating for the inclined trajectory direction due to nozzle deformation to allow ink to hit the surface of a sheet of paper at right angles.

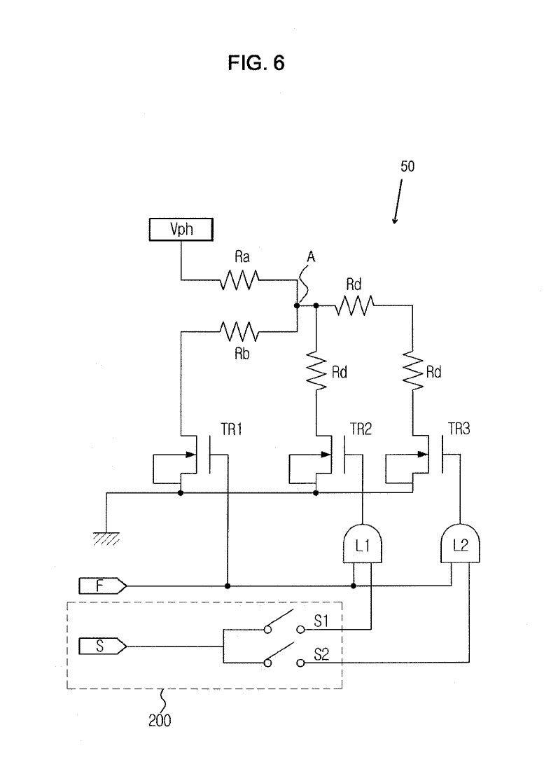

As illustrated in FIG. 6, a heater driver 50 according to an embodiment of the general inventive concept includes a time setter 200 to set a bubble generation time difference between the two divided heaters H1 and H2.

In FIG. 6, first and second resistors Ra and Rb, corresponding respectively to the resistive equivalent of the two divided heaters H1 and H2, are connected in series between a heater power source Vph and ground. In this embodiment, the resistance of the first resistor Ra is set to be lower than that of the second resistor Rb.

A first switching element, which may be a transistor TR1, is connected between one end of the second resistor Rb and ground. Three auxiliary resistors Rd are connected to a connection point A between the first and second resistors Ra and Rb. A second switching element, which may be a transistor TR2, is connected in series to one of the three auxiliary resistors Rd, and a third switching element, which may be a transistor TR3, is connected in series to the remaining ones of the three auxiliary resistors Rd.

As described above, the first through third transistors TR1, TR2, and TR3 are connected in parallel and function as switches for the first and second resistors Ra and Rb.

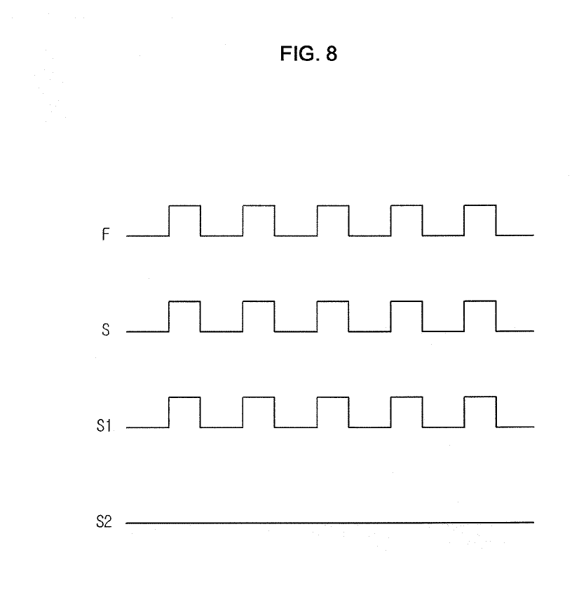

The first transistor TR1 is switched according to a fire pulse F signal (referring to FIG. 8) provided by a controller of the apparatus (not illustrated), and the second and third transistors TR2 and TR3 are switched according to outputs of first and second AND logic gates L1 and L2.

The fire pulse F signal, input to the time setter 200, and one of control pulses S1 and S2 output from the time setter 200 are input to the first and second AND logic gates L1 and L2. A mode setting pulse S (referring to FIG. 8) provided by the controller of the apparatus (not illustrated) may be used as an input to the time setter 200 to generate the control pulses S1 and S2 provided to first and second logic AND gates L1 and L2, respectively.

According to the fire pulse F input provided by the controller and the control pulses S1 and S2 output according to the setting of the time setter 200, different transistors are turned on at different times so that different currents flow through the divided heaters H1 and H2. This allows the two divided heaters H1 and H2 to generate different amounts of heat at different times, thereby causing a difference between their bubble generation times.

The following table illustrates such operations of the components of the heater driver.

| | | | | | | L1 | L2 |
|---|---|---|---|---|---|---|---|
| Heater - Resistance | | Transistor - State | | | F pulse | control | control |
| H1 | H2 (Rb > Ra) | TR1 | TR2 | TR3 | signal | pulse | pulse |
| Ra | Rb | ON | OFF | OFF | H | L | L |
| Ra | Rb // (Rd + Rd) | ON | OFF | ON | H | L | H |
| Ra | Rb // Rd | ON | ON | OFF | H | H | L |
| Ra | Rb // | ON | ON | ON | H | H | H |
| | (Rd//(Rd + Rd)) | | | | | | |

In a first operation mode for a nozzle 121 where S1 and S2 are both low, logic levels of the fire pulse F and the control pulses output from AND gates L1 and L2 (i.e., F, L1, L2) are, respectively, high, low, low (i.e., H, L, L), and only the first transistor TR1 is on while the second and third transistors TR2 and TR3 are off. In this example, no current flows through the three auxiliary resistors Rd and the same level of current flows through each of the first and second resistors Ra and Rb if any current flows through the first and second resistors Ra and Rb. The amount of heat generated by the first resistor Ra is smaller than that of the second resistor Rb since the resistance of the first resistor Ra is lower than that of the second resistor Rb. In this case, ink jetted by the nozzle 121 is set to hit a position on the sheet of paper two levels higher than a reference position where ink hits at right angles.

Next, in a second operation mode where logic levels of the fire pulse F signal and the control pulses (F, L1, L2) are (H, L, H), the first and third transistors TR1 and TR3 are on, while the second transistor TR2 is off. Here, no current flows through the auxiliary resistor Rd connected to the second transistor TR2. Accordingly, the level of current flowing through the second resistor Rb is lower than in the first operation mode. However, the amount of heat generated by the first resistor Ra is still set to be smaller than that of the second resistor Rb. In this case, ink jetted by the nozzle 121 is set to hit a position on the sheet of paper one level higher than the reference position where ink hits at right angles.

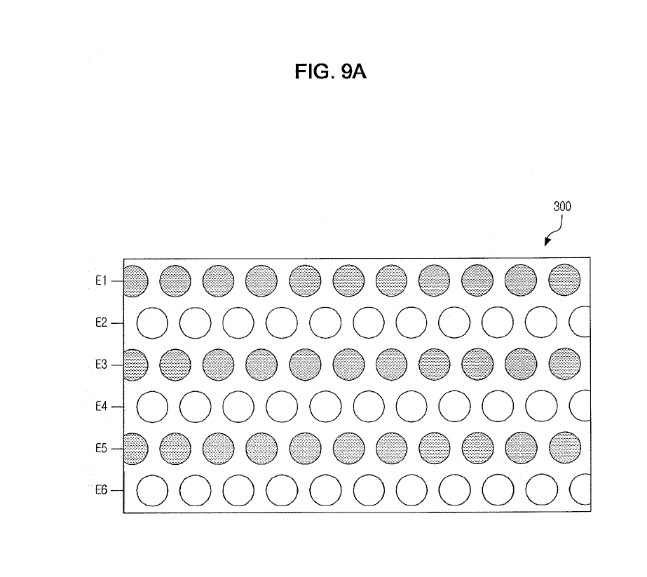

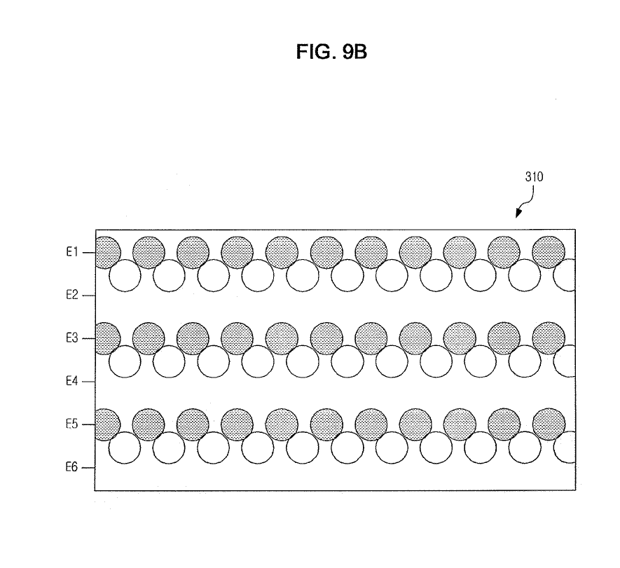

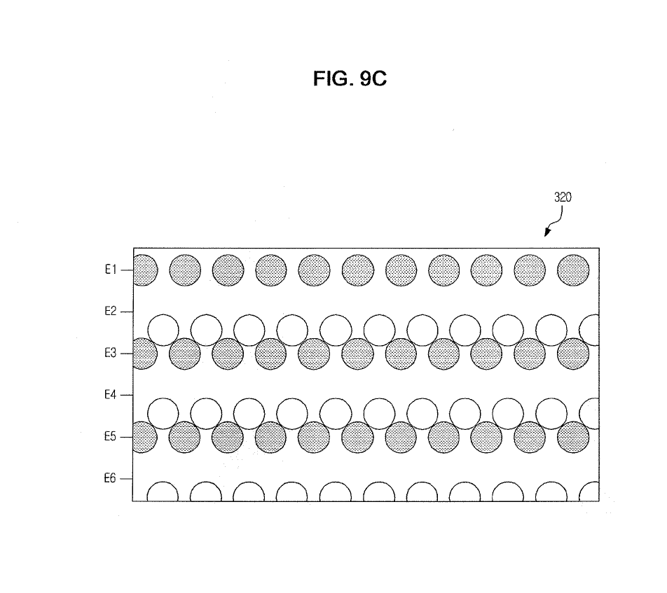

If estimation results of the characteristics of the head chip 100 indicate that positions hit by ink droplets jetted through the row of even nozzles of the head chip 100 deviate vertically from reference positions E2, E4, and E6 such that the hit positions are one level lower than the reference positions as illustrated in a head chip print pattern 320 of FIG. 9C, the second operation mode is applied so that ink droplets jetted by deformed nozzles hit the reference positions, i.e., so that rows of odd dots and rows of even dots are arranged uniformly as illustrated in a head chip print pattern 300 of FIG. 9A.

Next, in a third operation mode where logic levels of the fire pulse F and the control pulses (F, L1, L2) are (H, H, L), the first and second transistors TR1 and TR2 are on, while the third transistor TR3 is off. Here, no current flows through the two auxiliary resistors Rd connected to the third transistor TR3. As a result, the level of current flowing through the second resistor Rb is lower than in the second operation mode. In this case, the amount of heat generated by the first resistor Ra is set to be equal to that of the second resistor Rb.

Accordingly, when the third operation mode is applied to nozzles having no deformation, dots formed by ink droplets jetted through rows of odd and even nozzles are arranged uniformly as illustrated in the head chip print pattern 300 of FIG. 9A.

Next, in a fourth operation mode where logic levels of the fire pulse F and the control pulses (F, L1, L2) are (H, H, H), the first through third transistors TR1, TR2, and TR3 are all on. As a result, the level of current flowing through the second resistor Rb is lower than in the third operation mode. In this case, the amount of heat generated by the first resistor Ra is set to be greater to that of the second resistor Rb. Thus, in this mode, ink jetted by the nozzle 121 is set to hit a position on the sheet of paper one level lower than the reference position where ink hits at right angles.

If estimation results of the characteristics of the head chip 100 indicate that positions hit by ink droplets jetted through the row of even nozzles of head chip 100 deviate vertically from reference positions E2, E4, and E6 such that the hit positions are one level higher than the reference positions as illustrated in a head chip print pattern 310 of FIG. 9B, the fourth operation mode is applied so that ink droplets jetted by the deformed nozzles hit the reference positions, i.e., so that rows of odd dots and rows of even dots are arranged uniformly as illustrated in the head chip print pattern 300 of FIG. 9A.

According to the fire pulse F provided by the controller and the control pulses L1 and L2 output according to the setting of the time setter 200, different transistors are turned on to determine currents that flow through the divided heaters H1 and H2, as described above. This allows the two divided heaters H1 and H2 to generate different amounts of heat, thereby controlling the trajectory angle of ink injected by the nozzle.

For example, the third operation mode can be set by causing the fire pulse F signal and a mode setting pulse S to alternate between two logic levels H and L synchronously with each other, causing the control pulse S1 output from the time setter 200 to alternate between the two logic levels H and L synchronously with the fire pulse F signal, and maintaining the other control pulse S2 at a low logic level as illustrated in FIG. 8. The same operating principle as described above can be applied to operations to set the first, second, and fourth operation modes, as well.

Referring again to FIG. 6, the time setter 200 includes a plurality of switches to generate the control pulses S1 and S2 to be applied to the plurality of AND gates L1 and L2 and outputs the control pulses S1 and S2, each having one of two logic levels, high or low (i.e., H or L), selected according to the operation of the corresponding switch.

If, from estimation of the characteristics of the nozzles 121 of the head chip 100, it is determined that some nozzles 121 have been deformed, it may be necessary to permanently keep the setting state of the time setter 200 to compensate for the nozzle deformation since the nozzles 121 will continue to be deformed. In this case, the setting state of the time setter 200 is fixed using a general fusing device (not illustrated) that implements switch setting using a program.

Although this embodiment permanently fixes the setting state of the time setter 200 as described above, the general inventive concept may also provide another embodiment in which another control signal is applied to the setter to control the operations of the plurality of switches to change the levels of the control pulses as needed.

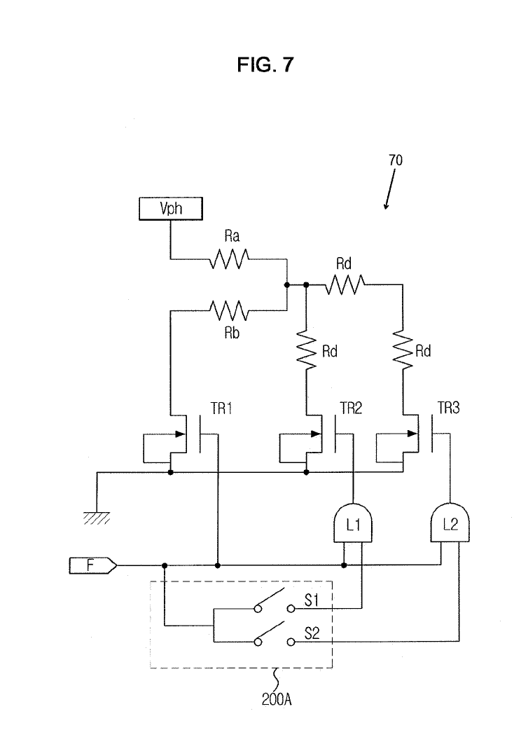

Referring to FIG. 7, another embodiment may provide a heater driver 70 which can implement all the operations described above by including all the components of that of FIG. 6 while receiving, as an input, only the fire pulse provided by the apparatus controller (not illustrated). As illustrated in FIG. 7, the fire pulse F signal is applied to the first transistor TR1 and the logic AND gates L1 and L2 and is also provided to a time setter 200A. This configuration can be employed because only one of the fire pulse F signal and the mode setting pulse S signal can be used as a common input since the fire pulse F signal and the mode setting pulse S signal are identical, as described above with reference to FIG. 8. A setting state of the time setter 200A used in the embodiment of FIG. 7, which is to compensate for nozzle deformation, may also be fixed using the fusing device described above.

As is apparent from the above description, the present general inventive concept provides an inkjet image forming apparatus and a method to control the same. For example, according to estimation results of the characteristics of nozzles of a manufactured head chip, it is possible to control and correct the trajectory angles of ink from deformed nozzles. Setting states to correct the ink trajectory angles can be permanently fixed and applied using a fusing device, thereby efficiently preventing a reduction in the image quality caused by nozzle deformation.

Although a few embodiments of the present general inventive concept have been illustrated and described, it would be appreciated by those skilled in the art that changes may be made in these embodiments without departing from the principles and spirit of the general inventive concept, the scope of which is defined in the appended claims and their equivalents.

What is claimed is:

1. An inkjet image forming apparatus, comprising:
a head chip including a plurality of nozzles to jet ink, a plurality of heaters arranged for each of the plurality of nozzles to control an ink trajectory angle of the nozzle, and a heater driver to drive the plurality of heaters,
wherein the heater driver includes at least one heater switch to allow a heater current to flow through the plurality of heaters which are connected in series, at least one auxiliary resistor connected to a connection point between the plurality of heaters, and at least one auxiliary switch to allow a heater current to flow through the at least one auxiliary resistor, and
wherein the current flowing through each of the plurality of heaters is provided according to operations of the at least one heater switch and the at least one auxiliary switch.

2. The inkjet image forming apparatus according to claim 1, wherein each of the at least one heater switch and the at least one auxiliary switch includes a transistor, and
wherein the heater driver further includes a setter to set an operating state of the at least one auxiliary switch.

3. The inkjet image forming apparatus according to claim 2, wherein the setter includes at least one switch and outputs a control pulse having at least two levels according to a setting of the at least one switch, and
wherein the setting of the at least one switch of the setter is fixed using a fusing device.

4. The inkjet image forming apparatus according to claim 2, wherein the setter receives a signal to control the at least one heater switch and outputs a control pulse.

5. The inkjet image forming apparatus according to claim 1, wherein the plurality of heaters are arranged in parallel in an ink chamber of each nozzle.

6. The inkjet image forming apparatus according to claim 1, wherein the plurality of heaters are two heaters connected in series and arranged in parallel to a conveyance direction of a print medium.

7. The inkjet image forming apparatus according to claim 1, wherein the plurality of heaters for each nozzle each include a resistance heating body and each resistive heating body of each nozzle has a different resistance value.

8. A method of controlling an inkjet image forming apparatus, comprising:
determining a trajectory angle of ink ejected from each of a plurality of nozzles on a head chip; and
selectively redirecting the trajectory angle of ink ejected from each of the nozzles by controlling an amount of heat applied to different portions of each of the nozzles.

9. The method according to claim 8, wherein the selectively redirecting the trajectory of ink ejected includes setting a correction value to allow ink ejected by a deformed nozzle to hit a reference position on a print medium such that ink ejected by the deformed nozzle hits the print medium at right angles.

10. The method of claim 8, wherein the selectively redirecting the trajectory angle of ink ejected from each of the nozzles is performed by providing a plurality of heaters for each nozzle.

11. The method according to claim 10, wherein controlling an amount of heat generated by the plurality of heaters includes controlling current flowing through the plurality of heaters.

12. The method of claim 10, wherein the plurality of heaters for each nozzle are disposed within an ink chamber.

13. The method of claim 8, wherein determining the trajectory angle includes comparing the trajectory angle of ink ejected from each of the plurality of nozzles on a head chip to a head chip print pattern having a plurality of reference positions corresponding to a predetermined trajectory angle of ink ejected from the nozzles of the head chip.

14. The method of claim 8, wherein selectively redirecting the trajectory angle of ink ejected from each of the nozzles includes applying a pulsed signal to control a time that the amount of heat is applied to the different portions of each of the nozzles.

15. An inkjet nozzle correction system, comprising:
a head chip including a plurality of inkjet nozzles arranged on the head chip in a first group and a second group; a plurality of heating elements disposed in an ink chamber of each inkjet nozzle of each group; and
a heater driver to selectively apply current to each of the plurality of heating elements of each nozzle such that a first current is applied to one of the plurality of heating elements of each nozzle of the first group of nozzles and a second current is applied to one of the plurality of heating elements of each nozzle of the second group of nozzles.

16. The inkjet nozzle correction system of claim 15, wherein each inkjet nozzle includes two heating elements, each having a different resistive value.

17. The inkjet nozzle correction system of claim 15, wherein the heater driver includes a plurality of switches to selectively apply each current.

18. The inkjet nozzle correction system of claim 17, wherein the heater driver further includes fused switching settings, the output of which is used to control the plurality of switches to selectivity apply each current.
